(19) United States
(12) Patent Application Publication
(10) Pub. No.: US 2025/0357526 A1
(43) Pub. Date: Nov. 20, 2025

(54) SYSTEMS AND METHODS FOR THERMAL MANAGEMENT OF A BATTERY MODULE

(71) Applicant: GM GLOBAL TECHNOLOGY OPERATIONS LLC, Detroit, MI (US)

(72) Inventors: Jeremie Dernotte, Canton, MI (US); Scott E. Parrish, Farmington Hills, MI (US)

(73) Assignee: GM GLOBAL TECHNOLOGY OPERATIONS LLC, Detroit, MI (US)

(21) Appl. No.: 18/664,898

(22) Filed: May 15, 2024

(51) Int. Cl. H01M 10/04; H01M 10/44; H01M 10/48; H01M 10/633; H01M 10/658; H01M 50/249; H02J 7/00

(52) U.S. Cl. CPC H01M 10/0468; H01M 10/441; H01M 10/486; H01M 10/633; H01M 10/658; H02J 7/0048; H01M 50/249

(57) ABSTRACT

Battery module data is received from a battery module sensor. A determination is made whether a battery cell anomaly has occurred in a battery cell of the battery module based on the battery module data. A command is issued to a compression control system to place the battery module in an uncompressed position based on the determination. The compression control system includes a first compression plate and a second compression plate. The plurality of battery cells are disposed between the first and second compression plates. A compression mechanism coupled to the first and second compression plates has a default compressed position to maintain the first and second compression plates in a first spaced apart position and the uncompressed position to place the first and second compression plates at a second space apart position responsive to the command. The first spaced apart position is less than the second spaced apart position.

### INTRODUCTION

The technical field generally relates to vehicles, and more particularly relates to thermal management of a battery module of a vehicle.

Electric vehicles are typically powered by a battery system including a plurality battery modules. Each battery module includes a plurality of battery cells. Examples of battery cells include, but are not limited to, pouch battery cells and prismatic battery cells. The occurrence of a battery cell anomaly in a battery cell of the battery module can lead to cell-to-cell propagation of the battery cell anomaly to the other battery cells in the battery module resulting in thermal propagation in the battery module.

Accordingly, it is desirable to provide systems and methods for thermal management of a battery module in an electric vehicle. Other desirable features and characteristics will become apparent from the subsequent detailed description and the appended claims, taken in conjunction with the accompanying drawings and the foregoing technical field and background.

### SUMMARY

A battery module thermal management system includes a processor and a memory communicatively coupled to the processor. The memory includes instructions that upon execution by the processor, cause the processor to: receive battery module data associated with a first battery module from at least one battery module sensor, the first battery module including a plurality of battery cells; determine whether a battery cell anomaly has occurred in at least one battery cell of the first battery module based on the battery module data; and issue a first command to a compression control system to place the first battery module in an uncompressed position based on the determination. The compression control system includes a first compression plate disposed at a first end of the first battery module; a second compression plate disposed at a second end of the first battery module, wherein the second end of the first battery module is opposite the first end of the first battery module and the plurality of battery cells are disposed between the first and second compression plates; and a compression mechanism is coupled to the first and second compression plates, the compression mechanism having a default compressed position to maintain the first and second compression plates in a first spaced apart position and the uncompressed position to place the first and second compression plates at a second space apart position responsive to the first command, the first space apart position being less than the second spaced apart position.

In at least one embodiment, each of the plurality of battery cells includes a first side having a first flat surface and a second side having a second flat surface, wherein the second side is opposite the first side and the first and second sides are parallel to the first and second compression plates.

In at least one embodiment, the plurality of battery cells are one of a plurality of pouch battery cells and a plurality of prismatic battery cells.

In at least one embodiment, the memory includes further instructions that upon execution by the processor, cause the processor to: receive the battery module data associated with the first battery module from the at least one battery module sensor, wherein the at least one battery module sensor includes at least one of a gas emission sensor, a module pressure sensor, and an acoustic emission sensor.

In at least one embodiment, the compression mechanism includes at least one tightening rod having a first end coupled to the first compression plate and a second end coupled to the second compression plate via a spring; and a solenoid coupled to the spring, wherein upon activation of the solenoid, the spring is released from a compressed state to an uncompressed state thereby moving the first and second compression plates from the first spaced apart position to the second space apart position.

In at least one embodiment, the memory includes further instructions that upon execution by the processor, cause the processor to upon a determination that the battery cell anomaly has occurred in the at least one battery cell of the first battery module: determine whether a state of charge (SOC) of the first battery module is greater than a SOC threshold; and issue a second command to a battery module SOC discharge system to decrease the SOC of the first battery module to below the SOC threshold based on the determination.

In at least one embodiment, the memory includes further instructions that upon execution by the processor, cause the processor to upon a determination that the battery cell anomaly has occurred in the at least one battery cell of the first battery module: issue the second command to the battery module state of charge (SOC) discharge system to decrease the SOC of the first battery module in parallel with the compression control system placing the first battery module in the uncompressed position.

In at least one embodiment, the memory includes further instructions that upon execution by the processor, cause the processor to: determine whether a vehicle including the first battery module is coupled to a grid charging system; and issue the second command to the battery module SOC discharge system to decrease the SOC of the first battery module by supplying energy from the first battery module back to the grid charging system.

In at least one embodiment, the memory includes further instructions that upon execution by the processor, cause the processor to issue the second command to the battery module SOC discharge system to decrease the SOC of the first battery module by activating operation of vehicle accessories of a vehicle including the first battery module and supplying energy from the first battery module to the vehicle accessories.

In at least one embodiment, the memory includes further instructions that upon execution by the processor, cause the processor to: determine whether a vehicle including the first battery module is parked; and issue the second command to the battery module SOC discharge system to decrease the SOC of the first battery module by activating operation of the propulsion system and a braking system of the vehicle and supplying energy from the first battery module to the propulsion system and the braking system.

In at least one embodiment, the memory includes further instructions that upon execution by the processor, cause the processor to upon a determination that the battery cell anomaly has occurred in the at least one battery cell of the first battery module: issue the second command to the battery module SOC discharge system to decrease the SOC of the first battery module by dissipating energy from the first battery module via a purpose integrated resistor.

In at least one embodiment, the memory includes further instructions that upon execution by the processor, cause the processor to upon a determination that the battery cell anomaly has occurred in the at least one battery cell of the first battery module: determine whether a SOC of the first battery module is greater than a SOC threshold; and issue a second command to a battery module SOC discharge system to decrease the SOC of a battery system including a plurality of battery modules based on the determination, the plurality of battery modules including the first battery module.

In at least one embodiment, the memory includes further instructions that upon execution by the processor, cause the processor to upon a determination that the battery cell anomaly has occurred in the at least one battery cell of the first battery module, increase coolant flow to the first battery module.

In at least one embodiment, each of the plurality of battery cells is coated with an intumescent paint.

In at least one embodiment, the memory includes further instructions that upon execution by the processor, cause the processor to upon a determination that the battery cell anomaly has occurred in the at least one battery cell of the first battery module, generate a battery system anomaly notification for display on a display device of a vehicle including the first battery module.

In at least one embodiment, the memory includes further instructions that upon execution by the processor, cause the processor to upon a determination that the battery cell anomaly has occurred in the at least one battery cell of the first battery module, generate a battery system anomaly notification for transmission to a vehicle service center associated with a vehicle including the first battery module.

In at least one embodiment, a vehicle includes a plurality of battery modules, the plurality of battery modules including the first battery module; each of the plurality of battery modules includes an associated compression control system and an associated battery module SOC discharge system; and the memory includes further instructions that upon execution by the processor, cause the processor to: receive a vehicle event notification associated with the vehicle: issue a third command to the compression control systems of each of the plurality of battery modules to place the battery module in an uncompressed position; and issue a fourth command to the battery module SOC discharge system associated with each of the plurality of battery modules to decrease the SOC of the battery module.

A method of thermal management of a battery module includes: receiving battery module data associated with a first battery module from at least one battery module sensor, the first battery module including a plurality of battery cells; determining whether a battery cell anomaly has occurred in at least one battery cell of the first battery module based on the battery module data; and issuing a first command to a compression control system to place the first battery module in an uncompressed position based on the determination, wherein the compression control system includes: a first compression plate disposed at a first end of the first battery module; a second compression plate disposed at a second end of the first battery module, wherein the second end of the first battery module is opposite the first end of the first battery module and the plurality of battery cells are disposed between the first and second compression plates; and a compression mechanism is coupled to the first and second compression plates, the compression mechanism having a default compressed position to maintain the first and second compression plates in a first spaced apart position and the uncompressed position to place the first and second compression plates at a second space apart position responsive to the first command, the first space apart position being less than the second spaced apart position.

A vehicle including a battery module thermal management system includes a processor; and a memory communicatively coupled to the processor. The memory includes instructions that upon execution by the processor, cause the processor to: receive battery module data associated with a first battery module from at least one battery module sensor, the first battery module including a plurality of battery cells; determine whether a battery cell anomaly has occurred in at least one battery cell of the first battery module based on the battery module data; and issue a first command to a compression control system to place the first battery module in an uncompressed position based on the determination, wherein the compression control system includes: a first compression plate disposed at a first end of the first battery module; a second compression plate disposed at a second end of the first battery module, wherein the second end of the first battery module is opposite the first end of the first battery module and the plurality of battery cells are disposed between the first and second compression plates; and a compression mechanism is coupled to the first and second compression plates, the compression mechanism having a default compressed position to maintain the first and second compression plates in a first spaced apart position and the uncompressed position to place the first and second compression plates at a second space apart position responsive to the first command, the first space apart position being less than the second spaced apart position.

In at least one embodiment, the memory includes further instructions that upon execution by the processor, cause the processor to upon a determination that the battery cell anomaly has occurred in the at least one battery cell of the first battery module: determine whether a state of charge (SOC) of the first battery module is greater than a SOC threshold; and issue a second command to a battery module SOC discharge system to decrease the SOC of the first battery module to below the SOC threshold based on the determination.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle including a battery module thermal management system in accordance with at least one embodiment;

FIG. 2 is a functional block diagram of a controller including a battery module thermal management system in accordance with at least one embodiment;

FIG. 3 is a flowchart representation of an exemplary method of thermal management of a battery module in accordance with at least one embodiment;

FIG. 4 is a functional block diagram representation of a battery module including a compression control system in accordance with at least one embodiment;

FIG. 5 is a functional block diagram representation of a battery system including a purpose integrated resistor in accordance with at least one embodiment; and

FIG. 6 is a flowchart representation of an exemplary method of thermal management of a battery module in response to a vehicle event in accordance with at least one embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

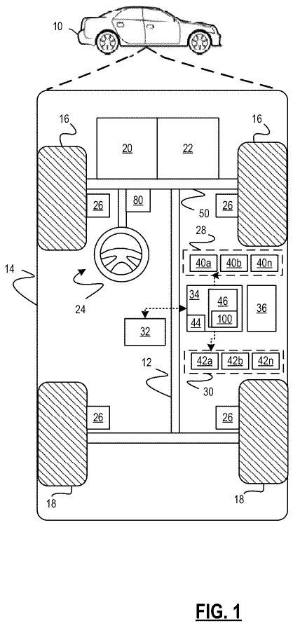

Referring to FIG. 1, a functional block diagram of a vehicle 10 including a battery module thermal management system 100 in accordance with at least one embodiment is shown. The vehicle 10 generally includes a chassis 12, a body 14, front wheels 16, and rear wheels 18. While the vehicle 10 is depicted in the illustrated embodiment as a passenger car, the vehicle 10 may be other types of vehicles including trucks, sport utility vehicles (SUVs), and recreational vehicles (RVs).

In various embodiments, the body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous or semi-autonomous vehicle that is automatically controlled to carry passengers and/or cargo from one place to another. For example, in an exemplary embodiment, the vehicle 10 is a so-called Level Two, Level Three, Level Four or Level Five automation system. Level two automation means the vehicle assists the driver in various driving tasks with driver supervision. Level three automation means the vehicle can take over all driving functions under certain circumstances. All major functions are automated, including braking, steering, and acceleration. At this level, the driver can fully disengage until the vehicle tells the driver otherwise. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the vehicle 10 generally includes a propulsion system 20 a transmission system 22, a steering system 24, a braking system 26, a sensor system 28, an actuator system 30, at least one data storage device 32, at least one controller 34, and a communication system 36. The controller 34 is configured to implement an automated driving system (ADS). The propulsion system 20 is configured to generate power to propel the vehicle. The propulsion system 20 may, in various embodiments, include an internal combustion engine, an electric machine such as a traction motor, a fuel cell propulsion system, and/or any other type of propulsion configuration. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The braking system 26 is configured to provide braking torque to the vehicle wheels 16-18. The braking system 26 may, in various embodiments, include friction brakes, brake by wire, a regenerative braking system such as an electric machine, and/or other appropriate braking systems. In at least one embodiment, the battery module thermal management system 100 is communicatively coupled to the propulsion system 20 and the braking system 26.

The steering system 24 is configured to influence a position of the of the vehicle wheels 16. While depicted as including a steering wheel and steering column, for illustrative purposes, in some embodiments contemplated within the scope of the present disclosure, the steering system 24 may not include a steering wheel and/or steering column. The steering system 24 includes a steering column coupled to an axle 50 associated with the front wheels 16 through, for example, a rack and pinion or other mechanism (not shown). Alternatively, the steering system 24 may include a steer by wire system that includes actuators associated with each of the front wheels 16.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, and/or other sensors. In various embodiments, the sensor system 28 includes a biometric sensor system configured to sense occupant biometric data of one or more occupants of the vehicle 10. In various embodiments, the sensor system 28 includes a vehicle environment sensor system configured to sense vehicle environmental data. In at least one embodiment, the battery module thermal management system 100 is communicatively coupled to the sensor system 28. In at least one embodiment, the sensor system 28 includes battery module sensors. Examples of battery module sensors include, but are not limited to, a gas emission sensor, a module pressure sensor, and an acoustic emission sensor. The battery module sensors are configured to provide battery module data.

The vehicle dynamics sensors provide vehicle dynamics data including longitudinal speed, yaw rate, lateral acceleration, longitudinal acceleration, etc. The vehicle dynamics sensors may include wheel sensors that measure information pertaining to one or more wheels of the vehicle 10. In one embodiment, the wheel sensors comprise wheel speed sensors that are coupled to each of the wheels 16-18 of the vehicle 10. Further, the vehicle dynamics sensors may include one or more accelerometers (provided as part of an Inertial Measurement Unit (IMU)) that measure information pertaining to an acceleration of the vehicle 10. In various embodiments, the accelerometers measure one or more acceleration values for the vehicle 10, including latitudinal and longitudinal acceleration and yaw rate.

The actuator system 30 includes one or more actuator devices 42a-42n that control one or more vehicle features such as, but not limited to, the propulsion system 20, the transmission system 22, the steering system 24, and the braking system 26. In various embodiments, the vehicle features can further include interior and/or exterior vehicle features such as, but are not limited to, doors, a trunk, and cabin features such as air, music, lighting, etc. (not numbered).

The communication system 36 is configured to wirelessly communicate information to and from other entities 48, such as but not limited to, other vehicles (“V2V” communication,) infrastructure (“V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in the ADS of the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10. In various embodiments, the controller(s) 34 are configured to implement ADS.

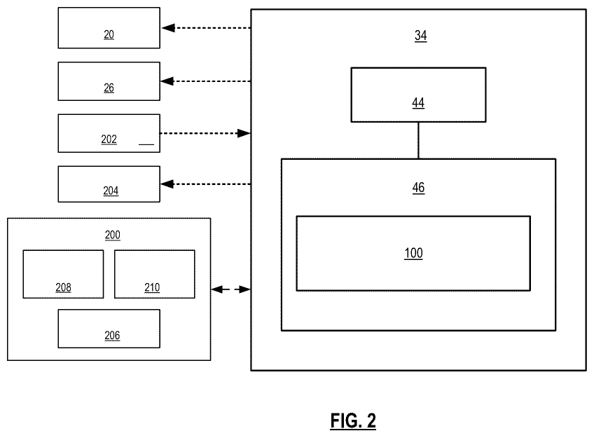

Referring to FIG. 2, a functional block diagram of a controller 34 including a battery module thermal management system 100 in accordance with at least one embodiment is shown. A battery system is used to power a vehicle 10. The battery system includes a plurality of battery modules 200. Each battery module 200 includes a plurality of battery cells. In at least one embodiment, the battery cells are lithium-ion battery cells. In alternative embodiments, the battery cells may be other types of battery cells. In at least one embodiment, the controller 34 is configured to manage a single battery module 200. In other words, a different controller 34 is dedicated to managing each individual battery modules 200 in the battery system. In alternative embodiments, the controller 34 is a battery management system that is configured to manage all of the battery modules 200 in the battery system of the vehicle 10.

The controller 34 includes at least one processor 44 and at least one memory 46. The at least one processor 44 is a programable device that includes one or more instructions stored in or associated with the at least one memory 46. The at least one memory 46 includes instructions that the at least one processor 44 is configured to execute. The at least one memory 46 includes an embodiment of the battery module thermal management system 100. The controller 34 is configured to be communicatively coupled to the battery module, 200, a propulsion system 20 of the vehicle 10, a braking system 26 of the vehicle 10, a vehicle event detection system 202 of the vehicle 10, and a vehicle display device 204 of the vehicle 10. The battery module 200 includes one or more battery module sensors 206, a compression control system 208, and a battery module state of charge (SOC) discharge system 210.

The controller 34 may include additional components that facilitate operation of the battery module thermal management system 100. The operation of the battery module thermal management system 100 will be described in greater detail below.

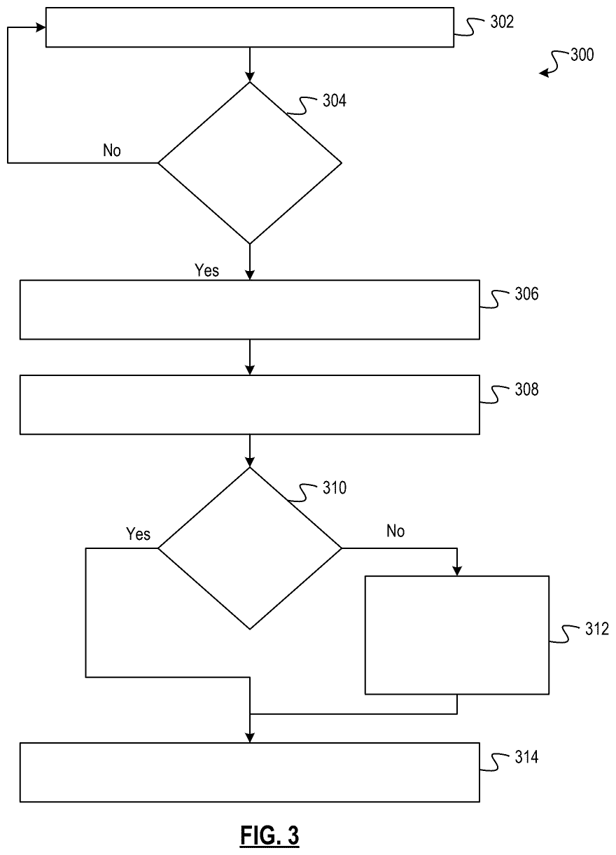

Referring to FIG. 3, a flowchart representation of an exemplary method 300 of thermal management of a battery module 200 in accordance with at least one embodiment is shown. The method 300 will be described with reference to an exemplary implementation of an embodiment of a battery module thermal management system 100. A vehicle 10 includes the battery module 200. The method 300 is implemented when a battery system of the vehicle 10 including the battery module 200 is in the process of being charged, is parked, or under driving conditions. As can be appreciated in light of the disclosure, the order of operation within the method 300 is not limited to the sequential execution as illustrated in FIG. 3 but may be performed in one or more varying orders as applicable and in accordance with the present disclosure.

At 302, the battery module thermal management system 100 receives battery module data from one or more battery module sensors 206. Examples of battery module sensors 206 include, but are not limited to, a gas emission sensor, a module pressure sensor, and an acoustic emission sensor.

At 304, the battery module thermal management system 100 determines whether a battery cell anomaly has occurred in a battery cell of the battery module 200 based on the received battery module data. A battery cell anomaly may be a precursor to a thermal propagation situation in a battery module 200. Early detection of battery cell anomalies in a battery module 200 prior to the degradation of the battery module 200 to a thermal propagation situation enables the battery module thermal management system 100 to implement actions to mitigate and/or prevent the occurrence of thermal propagation in the battery module 200.

An example of a battery cell anomaly is a short. During the initial stages of the battery cell anomaly, the short is a soft short with a high resistance. Over time, the resistance decreases gradually leading to a complete short leading to a thermal propagation situation within the battery module 200 containing the battery cell associated with the battery cell anomaly. In many instances battery cell degradation can occur in a battery module 200 due to the presence of a foreign object in the battery cell. The foreign object may have been introduced into the battery cell during the manufacturing process.

When an occurrence of a battery cell anomaly begins in a battery cell of a battery module 200, the battery cell begins to emit flammable and/or noxious gasses. The gas emission sensor disposed within or within close proximity to the battery module 200 is configured to detect when such gases are emitted by a battery cell in the battery module 200. The emission of the gases typically results in an increase in pressure within the battery module 200. The module pressure sensor is configured to detect increases in pressure within the battery module 200. In addition, when the battery cell anomaly occurs, the battery cell often emits sounds that are detectable by the acoustic emission sensor.

The battery module thermal management system 100 determines whether a battery cell anomaly has occurred in a battery cell of the battery module 200 based on whether the battery module data indicates the presence of gases, an increase in pressure within the battery module, and/or the generation of acoustics.

If the battery module thermal management system 100 determines that a battery cell anomaly has not occurred in a battery cell of the battery module 200, the method 300 returns to 302. If the battery module thermal management system 100 determines that a battery cell anomaly has occurred in a battery cell of the battery module 200, the method 300 proceeds to 306.

At 306, the battery module thermal management system 100 generates a battery system anomaly notification for display on a vehicle display device 204 of the vehicle 10. In at least one embodiment, the battery module thermal management system 100 is configured to generate a battery system anomaly notification for transmission to a vehicle service center associated with the vehicle 10.

At 308, the battery module thermal management system 100 issues a command to a compression control system 208 of the battery module 200 to place the battery module 200 in an uncompressed position.

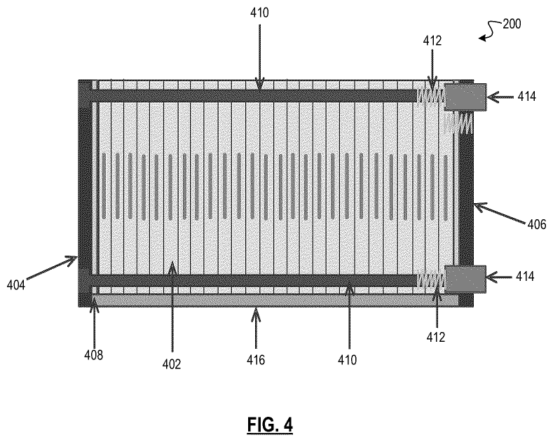

Referring to FIG. 4, a functional block diagram representation of a battery module 200 including a compression control system 208 in accordance with at least one embodiment is shown. The battery module 200 includes a plurality of battery cells 402. The battery cells 402 are lithium-ion battery cells. In at least one embodiment, the battery cells 402 are pouch battery cells 402. In at least one embodiment, the battery cells 402 are prismatic battery cells. In at least one embodiment, each of the plurality of battery cells 402 includes a first side having a flat surface and a second side having a flat surface. The second side of the battery cell 402 is opposite the first side of the battery cell 402.

The compression control system 208 includes a first compression plate 404 disposed at one end of the battery module 200 and a second compression plate 406 disposed at the other end of the battery module 200. The plurality of battery cells 402 of the battery module 200 are disposed between the first compression plate 404 and second compression plate 406. The first and second sides of each battery cell 402 are parallel to the first and second compression plates 404, 406. The battery cells 402 are arranged between the first and second compression plates 404, 406 so that a flat surface of one battery cell 402 is proximate a flat surface of an adjacent battery cell 402.

In at least one embodiment, a compression pad 408 is disposed between each compression plate 404, 406 and the battery cell 402 disposed adjacent that compression plate 404, 406. The compression control system 208 includes a compression mechanism. In at least one embodiment, the compression mechanism includes four tightening rods 410, four springs 412, and four solenoids 414. Each tightening rod 410 has one end coupled to the first compression plate 404 and the other end coupled to the second compression plate 406 via a spring 412. A solenoid 414 is coupled to each spring 412.

The compression mechanism has a default compressed position. The battery cells 402 are compressed between the first and second compression plates 404, 406 when the compression mechanism is in the default compressed position. The first and second compression plates 404, 406 are maintained at a first spaced apart position by the compression mechanism in the default compressed position. In the default compressed position, the springs 412 are maintained in a compressed state. Upon activation of the solenoids 414, the springs 412 are released from the compressed state into an uncompressed state thereby moving the first compression plate 404 and the second compression plate 406 from the first spaced apart position to a second spaced apart position. The second spaced apart position is greater than the first spaced apart position. The solenoids 414 are activated in response to the command to place the battery module 200 in the uncompressed position.

When the battery module thermal management system 100 issues the command to the compression control system 208 of the battery module 200 to place the battery module 200 in the uncompressed position at 308, the compression mechanism places the battery module 200 in the uncompressed position by increasing the distance between the first compression plate 404 and the second compression plate 406 to the second spaced apart position. Placing the battery module 200 in the uncompressed position increases the space between adjacent the battery cells 402 in the battery module 200.

Uncompressed battery cells 402 typically have a greater resistance to external heating than uncompressed battery cells 402. Uncompressed battery cells 402 may take longer heating periods and higher temperatures than compressed battery cells 402 to trigger a thermal propagation condition of the battery module 200. Without compression, internal delamination of layers during heating may play a role in preventing an occurrence of an internal short within the battery module 200 thereby preventing and/or mitigating a thermal propagation situation. Decompression of the battery cells 402 within the battery module 200 increases cell-to-cell contact resistance and may create an air gap between adjacent battery cells 402 within the battery module 200.

In at least one embodiment, the battery module 200 includes a cooling plate 416. Upon a determination by the battery module thermal management system 100 that a battery cell anomaly has occurred in a battery cell 402 of the battery module 200, the battery module thermal management system 100 coordinates an increase in coolant flow to the coolant plate 416.

In at least one embodiment, the battery cells 402 in the battery module 200 are coated with an intumescent paint. Intumescent paint is a fire protection coating. When the battery module 200 is placed in the uncompressed position, the intumescent paint is provided with space to expand upon exposure to heat and provide an insulating film around the battery cell 402 thereby mitigating a thermal propagation situation within the battery module 200.

In at least one embodiment, the battery module 200 is immersed in coolant to enable immersion cooling. When the battery module 200 is placed in the uncompressed position, the coolant flows between the battery cells 402 in the battery module 200 thereby mitigating a thermal propagation situation within the battery module 200.

Referring back to FIG. 3, at 310, the battery module thermal management system 100 determines whether a state of charge (SOC) of the battery module 200 is below a SOC threshold. The SOC threshold defines an SOC level for the battery cells in the battery module 200 that may prevent the occurrence of thermal propagation within the battery module 200 or may prevent cell-to-cell propagation in the event that thermal propagation has already begun in the battery cell experiencing the battery cell anomaly. In at least one embodiment, the SOC threshold is determined based on a chemistry and/or configuration of the battery cells in the battery module 200.

If the battery module thermal management system 100 determines that the state of charge (SOC) of the battery module 200 is not below the SOC threshold, the battery module thermal management system 100 issues a command to a battery module SOC discharge system 210 to decrease the SOC of the battery module 200 to below the SOC threshold at 312. When a battery cell anomaly is detected in a battery module 200, decreasing the SOC of the battery module 200 below the SOC threshold may bring the battery cell SOC down to safer levels that may prevent the occurrence of thermal propagation within the battery module 200 or prevent cell-to-cell propagation in the event that thermal propagation has already begun in the battery cell experiencing the battery cell anomaly.

In at least one embodiment, the battery module thermal management system 100 issues the command to the compression control system 208 to uncompress the battery module 200 and the command to the battery module SOC discharge system 210 to decrease the SOC of the battery module 200 to below the SOC threshold as the same time so that placing the battery module 200 in the uncompressed position occurs in parallel with decreasing the SOC of the battery module 200.

In at least one embodiment, the battery module thermal management system 100 determines whether the battery system of the vehicle 10 including the battery module 200 is coupled to a grid charging system. If the battery module thermal management system 100 determines that the battery system of the vehicle 10 including the battery module 200 is coupled to a grid charging system, the battery module thermal management system 100 issues a command to the battery module SOC discharge system 210 to decrease the SOC of the battery module 200 by supplying energy from the battery module 200 back to the grid charging system. The energy in the battery module 200 is dissipated via the grid charging system thereby reducing the SOC of the battery module 200. In at least one embodiment, the battery module SOC discharge system 210 coordinates the dissipation of the energy in the battery module 200 back to the grid charging system until the SOC of the battery module 200 falls below the SOC threshold.

In at least one embodiment, the battery module thermal management system 100 issues a command to the battery module SOC discharge system 210 to decrease the SOC of the battery module 200 by powering on one or more vehicle accessories of the vehicle 10 and supplying energy from the battery module 200 to the one or more vehicle accessories. An example of a vehicle accessory is an air conditioning system of the vehicle 10. In at least one embodiment, the battery module SOC discharge system 210 coordinates the dissipation of the energy in the battery module 200 by supplying energy to the one or more vehicle accessories until the SOC of the battery module 200 falls below the SOC threshold.

In at least one embodiment, the battery module thermal management system 100 determines whether the vehicle 10 including the battery module 200 is parked. If the battery module thermal management system 100 determines that the vehicle 10 including the battery module 200 is parked, the battery module thermal management system 100 issues a command to the battery module SOC discharge system 210 to decrease the SOC of the battery module 200 by powering on the propulsion system 20 of the vehicle 10, activating the braking system 26 of the vehicle 10, and supplying energy from the battery module 200 to the propulsion system 20 and the braking system 26. In at least one embodiment, the battery module SOC discharge system 210 coordinates the dissipation of the energy in the battery module 200 by supplying energy from the battery module 200 to the propulsion system 20 and the braking system 26 until the SOC of the battery module 200 falls below the SOC threshold.

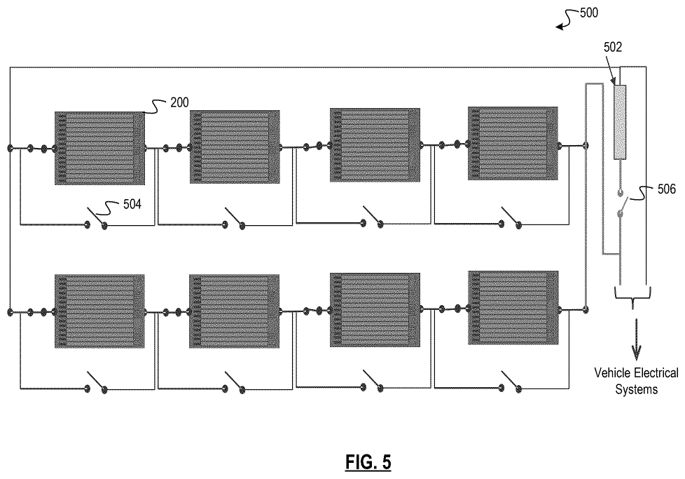

In at least one embodiment, the battery module thermal management system 100 issues a command to the battery module SOC discharge system 210 to decrease the SOC of the battery module 200 by dissipating energy from the battery module 200 via a purpose integrated resistor 502. Referring to FIG. 5, a functional block diagram representation of a battery system 500 including a purpose integrated resistor 502 in accordance with at least one embodiment is shown. The battery system 500 includes a plurality of battery modules 200. Each of the battery modules 200 is coupled to a bypass switch 504. Under normal operating conditions, the bypass switches 504 and the resistor switch 506 are maintained in an open position. When the battery module thermal management system 100 detects a battery cell anomaly in one of the battery modules 200, that battery module 200 is identified as a faulty battery module 200. The battery module thermal management system 100 coordinates closing the bypass switches 504 for the healthy battery modules 200, closing the resistor switch 506, and maintaining the bypass switch 504 for the faulty battery module 200 in the open position thereby enabling the dissipation of energy from the faulty battery module 200 via the purpose integrated resistor 502. In at least one embodiment, the purpose integrated resistor 502 is disposed on a cooling plate with the resistor switch 506.

Referring back to FIG. 3, when the battery module thermal management system 100 issues the command to the battery module SOC discharge system 210 to decrease the SOC of the battery module 200 to below the SOC threshold at 312, one or more of the methods of decreasing the SOC of the battery module 200 to below the SOC threshold described above may be used in combination to decrease the SOC of the battery module 200. At 314, the battery module thermal management system 100 generates a vehicle service notification for display on the vehicle display device 204.

If at 310, the battery module thermal management system 100 determines that the state of charge (SOC) of the battery module 200 is below the SOC threshold, the method 300 proceeds to 314. At 314, the battery module thermal management system 100 generates a vehicle service notification for display on the vehicle display device 204.

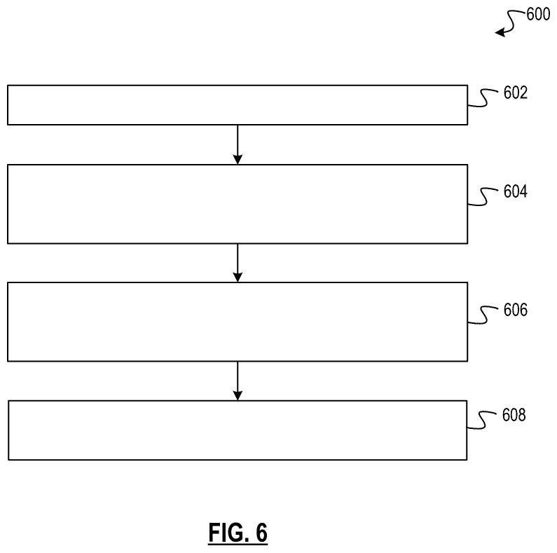

Referring to FIG. 6, a flowchart representation of an exemplary method 600 of thermal management of a battery module 200 in response to a vehicle event in accordance with at least one embodiment is shown. The method 600 will be described with reference to an exemplary implementation of an embodiment of a battery module thermal management system 100 of a vehicle 10. The vehicle 10 includes a battery system. The battery system includes a plurality of battery modules 200. As can be appreciated in light of the disclosure, the order of operation within the method 600 is not limited to the sequential execution as illustrated in FIG. 6 but may be performed in one or more varying orders as applicable and in accordance with the present disclosure.

At 602, the battery module thermal management system 100 receives a vehicle event notification from a vehicle event detection system 202. In at least one embodiment, the vehicle event detection system 202 is configured to determine whether a vehicle event has occurred based on sensor data received from the sensor system 28 of the vehicle 10. If the vehicle event detection system 202 determines that a vehicle event has occurred, the vehicle event detection system 202 is configured to generate the vehicle event notification. The vehicle event detection system 202 is configured to transmit the generated vehicle event notification to the battery module thermal management system 100. A vehicle event may include contact between the vehicle 10 and another vehicle or contact between the vehicle 10 and an object that may result in damage to the vehicle battery system and increase a risk of a potential battery module thermal propagation situation.

At 604, the battery module thermal management system 100 issues a command to the compression control system 208 of each of the battery modules 200 in the battery system of the vehicle 10 to place the battery module 200 in an uncompressed position. At 606, the battery module thermal management system 100 issues a command to the battery module SOC discharge systems 210 of each of the battery modules 200 in the battery system of the vehicle 10 to decrease the SOC of the battery module 200 by dissipating energy from the battery modules 200. One of more of the methods of dissipating energy from battery modules 200 described above may be used. In at least one embodiment, the battery module thermal management system 100 issues the command to the compression control systems 208 of each of the battery modules 200 in parallel with issuing the command to the battery module SOC discharge systems 210 of each of the battery modules 200 so that the battery modules 200 are placed in an uncompressed state in parallel with the dissipation of energy from the battery modules 200. At 608, the battery module thermal management system 100 generates a handle vehicle carefully notification for display on the vehicle display device 204.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A battery module thermal management system comprising:
a processor; and
a memory communicatively coupled to the processor, the memory comprising instructions that upon execution by the processor, cause the processor to:
receive battery module data associated with a first battery module from at least one battery module sensor, the first battery module comprising a plurality of battery cells;
determine whether a battery cell anomaly has occurred in at least one battery cell of the first battery module based on the battery module data; and
issue a first command to a compression control system to place the first battery module in an uncompressed position based on the determination, wherein the compression control system comprises:
a first compression plate disposed at a first end of the first battery module;
a second compression plate disposed at a second end of the first battery module, wherein the second end of the first battery module is opposite the first end of the first battery module and the plurality of battery cells are disposed between the first and second compression plates; and
a compression mechanism is coupled to the first and second compression plates, the compression mechanism having a default compressed position to maintain the first and second compression plates in a first spaced apart position and the uncompressed position to place the first and second compression plates at a second space apart position responsive to the first command, the first space apart position being less than the second spaced apart position.

2. The system of claim 1, wherein each of the plurality of battery cells comprises a first side having a first flat surface and a second side having a second flat surface, wherein the second side is opposite the first side and the first and second sides are parallel to the first and second compression plates.

3. The system of claim 1, wherein the plurality of battery cells comprises one of a plurality of pouch battery cells and a plurality of prismatic battery cells.

4. The system of claim 1, wherein the memory comprises further instructions that upon execution by the processor, cause the processor to:
receive the battery module data associated with the first battery module from the at least one battery module sensor, wherein the at least one battery module sensor comprises at least one of a gas emission sensor, a module pressure sensor, and an acoustic emission sensor.

5. The system of claim 1, wherein the compression mechanism comprises:
at least one tightening rod having a first end coupled to the first compression plate and a second end coupled to the second compression plate via a spring; and
a solenoid coupled to the spring, wherein upon activation of the solenoid, the spring is released from a compressed state to an uncompressed state thereby moving the first and second compression plates from the first spaced apart position to the second space apart position.

6. The system of claim 1, wherein the memory comprises further instructions that upon execution by the processor, cause the processor to upon a determination that the battery cell anomaly has occurred in the at least one battery cell of the first battery module:
determine whether a state of charge (SOC) of the first battery module is greater than a SOC threshold; and
issue a second command to a battery module SOC discharge system to decrease the SOC of the first battery module to below the SOC threshold based on the determination.

7. The system of claim 6, wherein the memory comprises further instructions that upon execution by the processor, cause the processor to upon a determination that the battery cell anomaly has occurred in the at least one battery cell of the first battery module:
issue the second command to the battery module state of charge (SOC) discharge system to decrease the SOC of the first battery module in parallel with the compression control system placing the first battery module in the uncompressed position.

8. The system of claim 6, wherein the memory comprises further instructions that upon execution by the processor, cause the processor to:
determine whether a vehicle including the first battery module is coupled to a grid charging system; and
issue the second command to the battery module SOC discharge system to decrease the SOC of the first battery module by supplying energy from the first battery module back to the grid charging system.

9. The system of claim 6, wherein the memory comprises further instructions that upon execution by the processor, cause the processor to issue the second command to the battery module SOC discharge system to decrease the SOC of the first battery module by activating operation of vehicle accessories of a vehicle including the first battery module and supplying energy from the first battery module to the vehicle accessories.

10. The system of claim 6, wherein the memory comprises further instructions that upon execution by the processor, cause the processor to:
determine whether a vehicle including the first battery module is parked; and
issue the second command to the battery module SOC discharge system to decrease the SOC of the first battery module by activating operation of a propulsion system and a braking system of the vehicle and supplying energy from the first battery module to the propulsion system and the braking system.

11. The system of claim 6, wherein the memory comprises further instructions that upon execution by the processor, cause the processor to upon a determination that the battery cell anomaly has occurred in the at least one battery cell of the first battery module:
issue the second command to the battery module SOC discharge system to decrease the SOC of the first battery module by dissipating energy from the first battery module via a purpose integrated resistor.

12. The system of claim 1, wherein the memory comprises further instructions that upon execution by the processor, cause the processor to upon a determination that the battery cell anomaly has occurred in the at least one battery cell of the first battery module:
determine whether a SOC of the first battery module is greater than a SOC threshold; and
issue a second command to a battery module SOC discharge system to decrease the SOC of a battery system including a plurality of battery modules based on the determination, the plurality of battery modules including the first battery module.

13. The system of claim 1, wherein the memory comprises further instructions that upon execution by the processor, cause the processor to upon a determination that the battery cell anomaly has occurred in the at least one battery cell of the first battery module, increase coolant flow to the first battery module.

14. The system of claim 1, wherein each of the plurality of battery cells is coated with an intumescent paint.

15. The system of claim 1, wherein the memory comprises further instructions that upon execution by the processor, cause the processor to upon a determination that the battery cell anomaly has occurred in the at least one battery cell of the first battery module, generate a battery system anomaly notification for display on a display device of a vehicle including the first battery module.

16. The system of claim 1, wherein the memory comprises further instructions that upon execution by the processor, cause the processor to upon a determination that the battery cell anomaly has occurred in the at least one battery cell of the first battery module, generate a battery system anomaly notification for transmission to a vehicle service center associated with a vehicle including the first battery module.

17. The system of claim 1, wherein:
a vehicle includes a plurality of battery modules, the plurality of battery modules including the first battery module;
each of the plurality of battery modules includes an associated compression control system and an associated battery module SOC discharge system; and
the memory comprises further instructions that upon execution by the processor, cause the processor to:
receive a vehicle event notification associated with the vehicle:
issue a third command to the compression control systems of each of the plurality of battery modules to place the battery module in an uncompressed position; and
issue a fourth command to the battery module SOC discharge system associated with each of the plurality of battery modules to decrease the SOC of the battery module.

18. A method of thermal management of a battery module comprising:
receiving battery module data associated with a first battery module from at least one battery module sensor, the first battery module comprising a plurality of battery cells;
determining whether a battery cell anomaly has occurred in at least one battery cell of the first battery module based on the battery module data; and
issuing a first command to a compression control system to place the first battery module in an uncompressed position based on the determination, wherein the compression control system comprises:
a first compression plate disposed at a first end of the first battery module;
a second compression plate disposed at a second end of the first battery module, wherein the second end of the first battery module is opposite the first end of the first battery module and the plurality of battery cells are disposed between the first and second compression plates; and
a compression mechanism is coupled to the first and second compression plates, the compression mechanism having a default compressed position to maintain the first and second compression plates in a first spaced apart position and the uncompressed position to place the first and second compression plates at a second space apart position responsive to the first command, the first space apart position being less than the second spaced apart position.

19. A vehicle including a battery module thermal management system comprising:
a processor; and
a memory communicatively coupled to the processor, the memory comprising instructions that upon execution by the processor, cause the processor to:
receive battery module data associated with a first battery module from at least one battery module sensor, the first battery module comprising a plurality of battery cells;
determine whether a battery cell anomaly has occurred in at least one battery cell of the first battery module based on the battery module data; and
issue a first command to a compression control system to place the first battery module in an uncompressed position based on the determination, wherein the compression control system comprises:
a first compression plate disposed at a first end of the first battery module;
a second compression plate disposed at a second end of the first battery module, wherein the second end of the first battery module is opposite the first end of the first battery module and the plurality of battery cells are disposed between the first and second compression plates; and
a compression mechanism is coupled to the first and second compression plates, the compression mechanism having a default compressed position to maintain the first and second compression plates in a first spaced apart position and the uncompressed position to place the first and second compression plates at a second space apart position responsive to the first command, the first space apart position being less than the second spaced apart position.

20. The vehicle of claim 19, wherein the memory comprises further instructions that upon execution by the processor, cause the processor to upon a determination that the battery cell anomaly has occurred in the at least one battery cell of the first battery module:
determine whether a state of charge (SOC) of the first battery module is greater than a SOC threshold; and
issue a second command to a battery module SOC discharge system to decrease the SOC of the first battery module to below the SOC threshold based on the determination.
